(19) United States
(12) Patent Application Publication
(10) Pub. No.: US 2003/0150974 A1
(43) Pub. Date: Aug. 14, 2003

(54) Electric controlled color change electro luminescent element

(76) Inventor: Chih-Yuan Wang, Taichung Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/061,231

(22) Filed: Feb. 4, 2002

(51) Int. Cl. G01J 1/32

(52) U.S. Cl. 250/205

(57) ABSTRACT

An electric controlled color change electro luminescent element is disclosed. An EL element is connected to a driving system by a first pin and a second pin. The driving system has a function of changing driving voltage. The driving system is switched through a switch for changing the way for supplying voltage or switching to different driving IC to change the output bias or current frequency. Thereby, the color and brightness of the EL element are changed.

### FIELD OF THE INVENTION

The present invention relates to an electric controlled color change electro luminescent element, and particularly to an electro luminescent element having a driving system to change the driving voltage and frequency so as to emit lights of different colors and chromaticity.

### BACKGROUND OF THE INVENTION

Referring to FIG. 7, a prior electric controlled color change electro luminescent element (EL element) is illustrated. The EL element has a thin film structure for applying to back light elements. In the EL element, an alternative current power system provides power to a front side electrode 91 and a backside electrode 92. Furthermore, the electric field from an AC current is utilized to induce the light emitting particles in the light emitting layer 93 interior the EL element (not shown). Therefore, light (for example, green light) is excited. Since the driving circuit of an EL element may generate a driving AC voltage. In this AC current, the light emitting particles in the light emitting layer emits light of single color. As a result, the use of the EL element is confined. Therefore, in other way, pigments or fluorescent dye is mixed in the EL element for changing the color of the EL element. However, this way still emits light of single color.

### SUMMARY OF THE INVENTION

Accordingly, the primary object of the present invention is to provide an electric controlled color change electro luminescent element. An EL element is connected to a driving system by a first pin and a second pin. The driving system has a function of changing driving voltage. The driving system is switched through a switch for changing the way for supplying voltage or switching to different driving IC to change the output bias or current frequency. Thereby, the color and brightness of the EL element are changed.

The various objects and advantages of the present invention will be more readily understood from the following detailed description when read in conjunction with the appended drawing.

### BRIEF DESCRIPTION OF THE DRAWINGS

FIG. 1 is an exploded perspective view of the EL element of the present invention.

FIG. 2 shows a circuit diagram of the first embodiment of the present invention, wherein the switch is switched to a first condition.

FIG. 3 is a circuit diagram of the first embodiment of the present invention, wherein the switch is switched to another condition.

FIG. 4 shows a CIE chromaticity diagram of the first, second and third embodiments of the present invention.

FIG. 5 shows a circuit diagram of the second embodiment of the present invention, wherein the switch is switched to one condition.

FIG. 6 shows a circuit diagram of the second embodiment of the present invention, wherein the switch is switched to another embodiment.

FIG. 7 is a structural cross section view of a prior EL element.

### DETAILED DESCRIPTION OF THE PREFERRED EMBODIMENTS

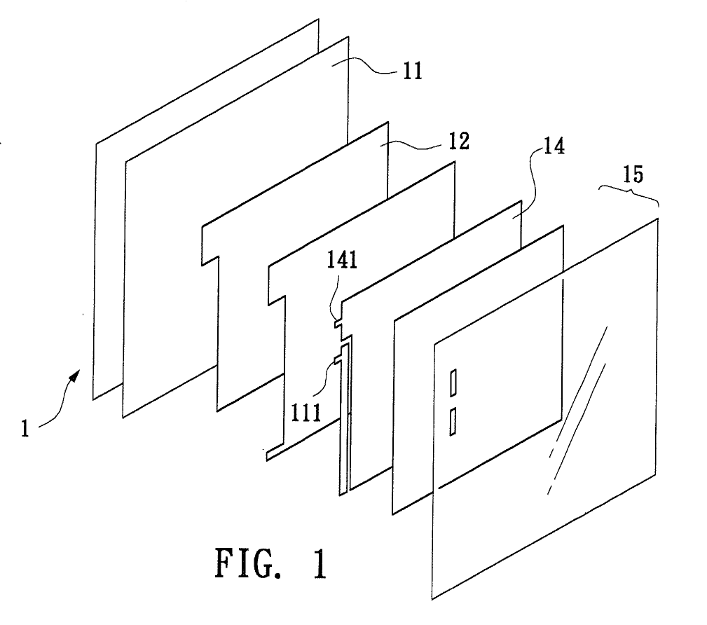

Referring to FIGS. 1 to 3, the electric controlled color change electro luminescent element of the present invention is illustrated. The electric controlled color change electro luminescent element is formed by overlapping a front side electrode 11, a light emitting layer 12, an electron-inducing layer 13, and a backside electrode 14. An insulating layer 15 is arranged at the exterior side. The front side electrode 11 and the backside electrode 14 have a first pin 111 and a second pin 141, respectively, which are extended to the outer side of the EL element 1. The first pin 111 is connected to a driving IC 2 (in this embodiment, it is an IC of D335A). The driving IC 2 is connected to a driving circuit 20 (in this embodiment, it is a standard circuit of D335A IC). Moreover, the driving IC 2 is connected to a power supply system 3 which is formed by serially connecting a first battery 31 and a second battery 32 (in this embodiment, the first battery 31 and second battery 32 are 1.5V DC batteries). A positive electrode of the first battery 31 is connected to the driving IC 2, and the negative electrode of the second battery 32 is connected to a switch 33. The switch 33 includes a first joint 331 and a second joint 332. The first joint 331 is connected with the second joint 332. The second joint 332 is connected between the first battery 31 and the second battery 32. Furthermore, the switch 33 is connected to the second pin 141. A point between the switch 33 and the second joint 332 is grounded. A capacitor 34 is connected to the driving IC 2 and the positive electrode connected to the first battery 31.

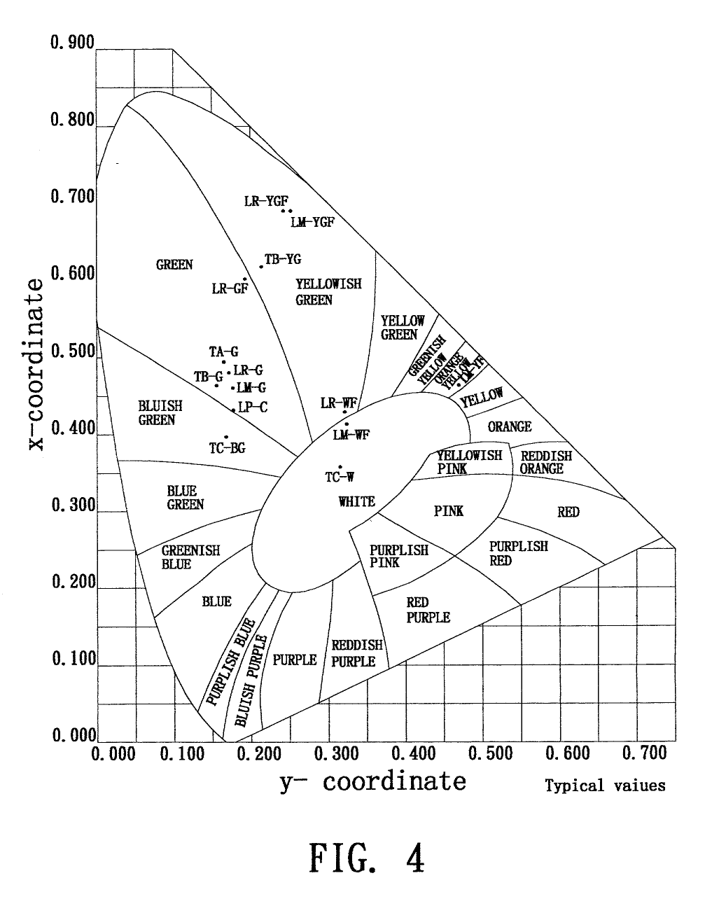

Referring to FIG. 4, a CIE chromaticity diagram is illustrated. When the switch 33 is switched to the first joint 331 (referring to FIG. 3), only the first battery 31 provides a 1.5V voltage to the EL element 1, and the voltage from the first battery 31 is converted from DC to AC through the driving circuit 20, wherein this AC current has a bias of 160Vₚ₋ₚ and a frequency of 220 Hz. When this AC current drives the EL element 1 to emit light. The light emitting layer 12 emits light with a brightness of 50 cd/m² and the chromaticity of CIE is 0.18 for x axis and 0.42 for y axis. As a result the color is green color.

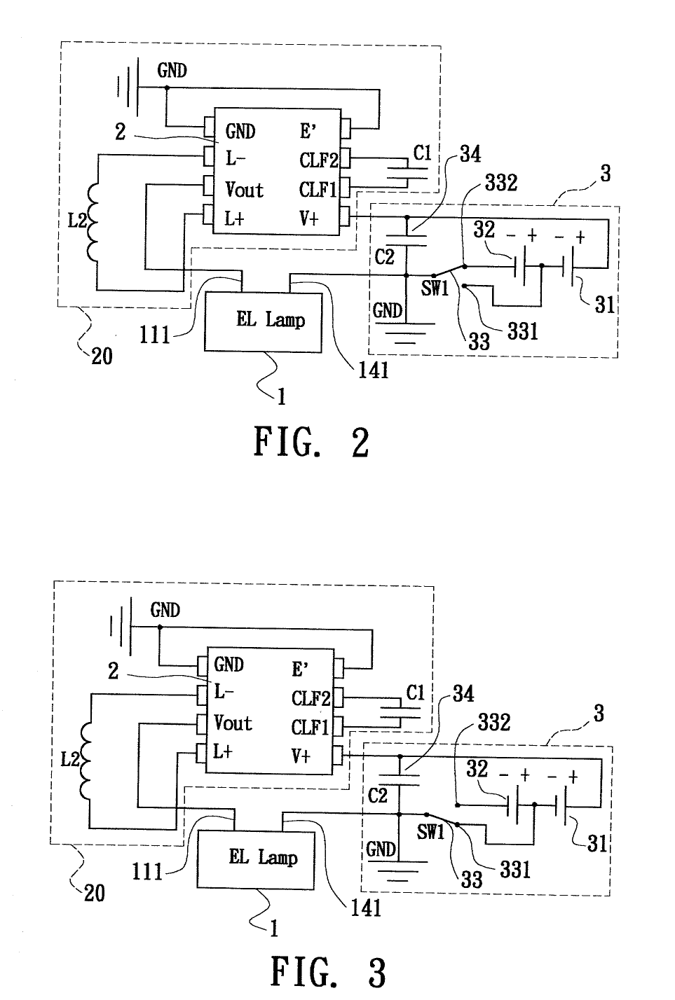

When the switch 33 is switched to the second joint 332 (referring to FIG. 2), the EL element 1 is provided with a voltage of 3.0V by serially connecting the first battery 31 and the second battery 32. This voltage is converted from DC to AC through the driving IC 2 and the driving circuit 20, wherein this AC current has a bias of 200Vₚ₋ₚ and a frequency of 475 Hz. When this AC current drives the EL element 1 to emit light, then the brightness of the light emitting layer 12 is increased to 170 cd/m² and the chromaticity of CIE is 0.17 for x axis and 0.34 for y axis. As a result the color is blue green color.

Comparison in the First Embodiment.

| Input DC | Output AC driving | | | | |
|---|---|---|---|---|---|
| driving | voltage | | Brightness | CIE | |
| voltage | Voltage | Frequency | cd/m² | x | y |
| 1.5 V-DC | 160 Vₚ₋ₚ | 220 Hz | 50 | 0.18 | 0.42 |
| 3.0 V-DC | 200 Vₚ₋ₚ | 475 Hz | 170 | 0.17 | 0.34 |

It is appreciated from above embodiment that in the conventional EL element 1, the light emitting layer 12 may have different vibrating frequency by changing driving voltage and frequency. Therefore, the color of the emitting light is changeable and the brightness can be increased. As a result, single EL element 1 can present various colors.

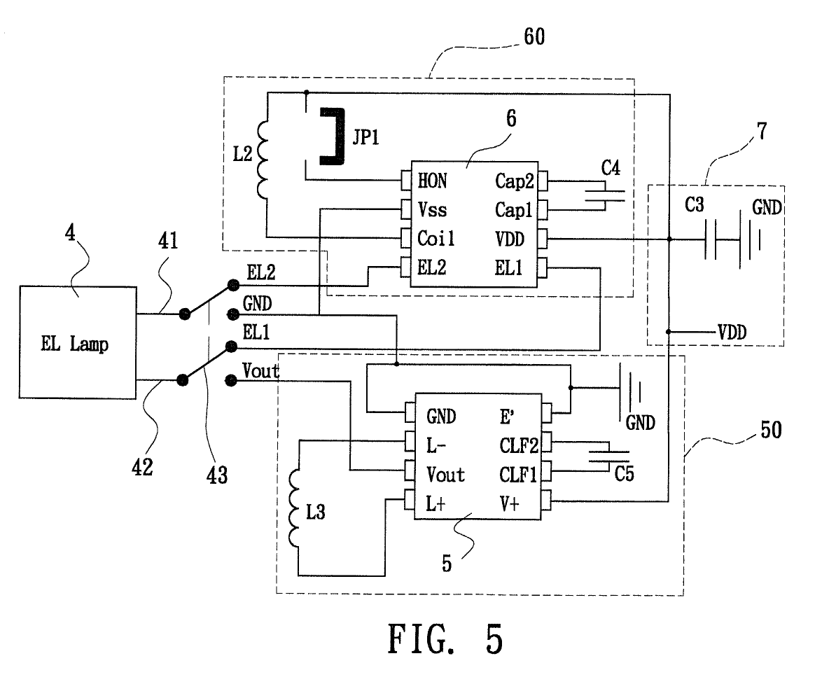

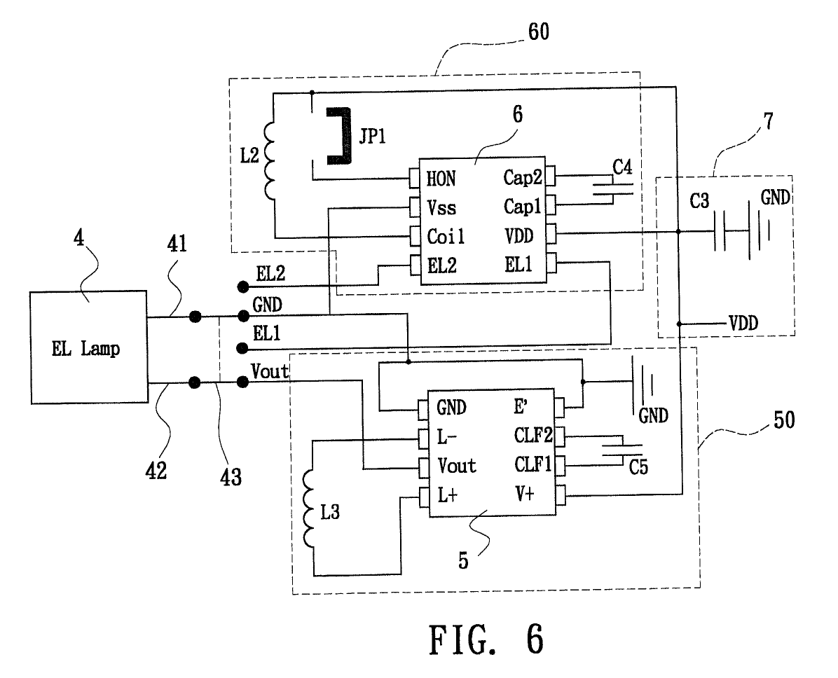

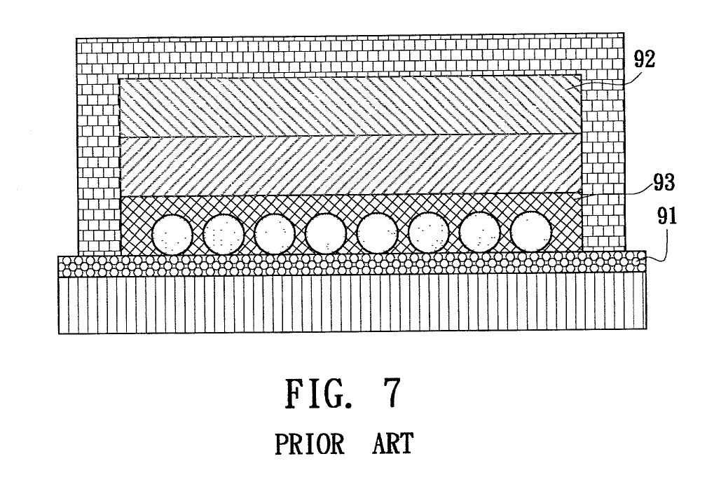

Many other examples are suitably used in the present invention. Referring to FIGS. 5 and 6, a second embodiment of the present invention is illustrated. The first pin 41 and second pin 42 of the EL element 4 have respective gated switches 4 which are interacted. The switch 4 may be connected to a front driving IC 5 (in this embodiment, it is an DCC335A IC) and a first driving circuit 50 communicable with the first driving IC 5 (in this embodiment, it is a D335 AIC standard circuit). Besides, the switch 43 may be switched to communicate with a second driving IC 6 (in this embodiment, it is a SP4422A IC). The second driving IC 6 is connected to the second driving circuit 60 (in this embodiment, it is a standard circuit of SP4422A IC). The first driving IC 5 and the first driving circuit 50 and the second driving IC 6 and the second driving circuit 60 are connected to a power supply system 7 (in this embodiment, it is a 1.5 V DC current).

When the switch 43 is switched to the first driving IC 5 and the second driving circuit 50 (referring to FIG. 6), the first driving IC 5 and the first driving circuit 50 converts the 1.5 V DC into an AC current with a bias of 190 Vₚ₋ₚ and 220 Hz. Therefore, the EL element 1 is driven to emit light with a brightness of 70 cd/m² and the chromaticity of CIE is 0.18 for x axis and 0.42 for y axis. As a result the color is green color.

When the switch 43 is switched to the second driving IC 6 and the second driving circuit 60 (referring to FIG. 5), the second driving IC 6 and the second driving circuit 60 (referring to FIG. 5) converts the 1.5V DC current into an AC current has a bias of 200Vₚ₋ₚ and a frequency of 475 Hz. When this AC current drives the EL element 1 to emit light, then the brightness of the light emitting layer 12 is increased to 170 cd/m² and the chromaticity of CIE is 0.17 for x axis and 0.34 for y axis. As a result the color is blue green color.

Comparison in the Second Embodiment.

| Output AC driving | | | | |
|---|---|---|---|---|
| voltage | | Brightness | CIE | |
| Voltage | Frequency | cd/m² | X | y |
| 190 Vₚ₋ₚ | 220 Hz | 70 | 0.18 | 0.42 |
| 200 Vₚ₋ₚ | 475 Hz | 170 | 0.17 | 0.34 |

Besides, in the third embodiment of the present invention, it is similar to the first embodiment. In the third embodiment, the EL element is mixed with fluorescent pigments. Under a driven voltage of 1.5V, the driving IC performs a DC to AC conversion so as to acquire an AC current of 160Vₚ₋ₚ and 220 Hz. When this Ac current drives the EL element to emit light, since the vibration frequency of 220 Hz will cause the brightness to decrease to 35 cd/m² due to the isolation of the fluorescent pigment, and the chromaticity of CIE is 0.28 for x axis and 0.42 for y axis. The color is pink.

| Input DC | Output AC driving | | | | |
|---|---|---|---|---|---|
| driving | voltage | | Brightness | CIE | |
| voltage | Voltage | Frequency | cd/m² | x | Y |
| 1.5 V-DC | 160 Vₚ₋ₚ | 220 Hz | 35 | 0.28 | 0.42 |
| 3.0 V-DC | 200 Vₚ₋ₚ | 475 Hz | 150 | 0.26 | 0.37 |

A voltage of 3.0V is provided to the EL element 1 by serially connect the first battery to the second battery. This voltage is performed with a DC to AC conversion so as to acquire an AC current with a bias of 200Vₚ₋ₚ and a frequency of 475 Hz. When this AC current drives the EL element to emit light, since the vibration frequency of 475 Hz will cause the brightness to increase to 50 cd/m², and the chromaticity of CIE is 0.26 for x axis and 0.37 for y axis. The color is white.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An electric controlled color change electro luminescent element having an EL element, the EL element being formed by overlapping a front side electrode, a light emitting layer, an electron-inducing layer, and a backside electrode; an insulating layer being arranged at an exterior side; the front side electrode and the backside electrode have a first pin and a second pin, respectively; the first pin and second pin being connected to a driving system having a changeable driving voltage and frequency, the driving system having at least one driving IC; the driving IC being connected to at least one driving circuit, and the driving IC being also connected to a power supply system; the power supply system providing power to a switch of the driving IC and EL element.

2. The electric controlled color change electro luminescent element as claim in claim 1, wherein the driving IC of the driving system is D355A IC, and the driving circuit is a standard circuit of D335A IC.

3. The electric controlled color change electro luminescent element as claim in claim 1, wherein the power supply system is formed by serially connecting a first battery and a second battery.

4. The electric controlled color change electro luminescent element as claim in claim 1, wherein the switch includes a first joint and a second joint, the first joint is connected to the second battery, and the switch is connected to a second pin of the EL element; a point between the switch and the EL element is grounded; a capacitor is connected to the driving IC and the positive electrode of the first battery.

5. The electric controlled color change electro luminescent element as claim in claim 1, wherein the driving system further includes a second driving IC; the second driving IC is a SP4422A IC, and the second driving IC is connected to a second driving circuit; and the second driving circuit is a standard circuit of SP4422A IC.

6. The electric controlled color change electro luminescent element as claim in claim 1, wherein the EL element is mixed with a pigment having a predetermined color.
